(19) United States
(12) Patent Application Publication
(10) Pub. No.: US 2015/0227338 A1
(43) Pub. Date: Aug. 13, 2015

(54) PORTABLE COMMUNICATION TERMINAL AND DATA RECEIVING METHOD

(71) Applicant: KYOCERA Corporation, Kyoto-shi, Kyoto (JP)

(72) Inventors: Makiko Hoshikawa, Arakawa-Im (JP); Takayuki Sato, Daito-shi (JP); Tomohiro Shimazu, Osaka-shi (JP)

(21) Appl. No.: 14/420,626

(22) PCT Filed: Jul. 12, 2013
(86) PCT No.: PCT/JP2013/069121

§ 371 Date: Feb. 9, 2015

(30) Foreign Application Priority Data
Aug. 9, 2012 (JP) 2012-176652

(51) Int. Cl. G06F 3/14; G09G 5/12; G06F 1/16

(52) U.S. Cl. CPC G06F 3/1446; G06F 1/1698; G09G 5/12; G09G 2370/20

(57) ABSTRACT

A data transfer system 1000 includes a portable communication terminal 10 and an information terminal 100. A data icon corresponding to stored data is displayed on a display of the information terminal 100. If a user performs a data reception function on the portable communication terminal 10, the portable communication terminal 10 and the information terminal 100 establish a short-distance wireless communication. At this time, if a first data icon is selected, a second data icon relevant to the first data icon is displayed on a display of the portable communication terminal 10. If the user moves the portable communication terminal 10 in this state so as to scoop the first data icon, the data corresponding to the first data icon is transferred to the portable communication terminal 10.

### FIELD OF ART

The present invention relates to a portable communication terminal and data receiving method, and more specifically, a portable communication terminal and data receiving method, capable of transferring data.

### BACKGROUND ART

A portable communication terminal which can transfer arbitrary data is known. In a certain mobile phone, it is possible to transmit and receive an e-mail, telephone directory data or data such as schedules by infrared rays. As a specific operation, a user of the mobile phone performs a predetermined operation from a menu screen first to display a list of data such as images. Next, the user selects arbitrary one out of the data being list-displayed. Next, “infrared transmission” is selected as a processing method for selected data. Then, when preparation at a communication partner is completed, infrared transmission of the selected data is performed.

### SUMMARY OF THE INVENTION

### Problems to be Solved by the Invention

However, a user who does not get used to operation of a mobile phone may be unable to perform the operating procedure mentioned above skillfully. Therefore, such a user requires time and effort when receiving arbitrary data, and therefore, cannot transmit and receive data easily.

Therefore, a primary object of the present invention is to provide a novel portable communication terminal and data receiving method.

Another object of the present invention is to provide a portable communication terminal and data receiving method, capable of receiving arbitrary data with a simple operation.

### Means for Solving the Problem

A first aspect of the present invention is a portable communication terminal capable of performing a short-distance wireless communication with an information terminal that displays a first image corresponding to stored data, comprising: a display module; an operation module; a display processing module that displays a second image relevant to the first image that is transmitted from the information terminal; a causing module that causes the information terminal to perform transfer of data corresponding to the first image when a reception operation is performed to the operation module during display of the second image; and a storing module that stores transferred data.

A second aspect of the present invention is a data receiving method in a portable communication terminal that can performs a short-distance wireless communication with an information terminal that displays a first image corresponding to stored data, and has a display module and an operation module, a processor of the portable communication terminal executing steps of: a display processing step that displays a second image relevant to the first image that is transmitted from the information terminal; a causing step that causes the information terminal to perform transfer of data corresponding to the first image when a reception operation is performed to the operation module during display of the second image; and a storing step that stores transferred data.

### Advantage of the Invention

According to the present invention, arbitrary data can be received with a simple operation.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view showing an example of structure of a data transfer system according to an embodiment of a present invention.

FIG. 2 shows an appearance of a portable communication terminal shown in FIG. 1, wherein FIG. 2 (A) shows an appearance of a main surface of the portable communication terminal and FIG. 2 (B) shows an appearance of another surface of the portable communication terminal.

FIG. 3 is a schematic view showing an example of electric structure of the portable communication terminal shown in FIG. 2.

FIG. 4 is an appearance view of an information terminal shown in FIG. 1.

FIG. 5 is a schematic view showing an example of electric structure of an information terminal shown in FIG. 2.

FIG. 6 is a schematic view showing an example of a detection space of a touch panel shown in FIG. 4.

FIG. 7 is a schematic view showing an example of a state where an operating position is detected in the detection space shown in FIG. 6.

FIG. 8 shows an example of an operation when selecting a data icon with the portable communication terminal shown in FIG. 1, wherein FIG. 8 (A) shows a state before selecting a first data icon and FIG. 8 (B) shows a state where the first data icon is being selected.

FIG. 9 is a schematic view showing an example of a state where a second data icon is being displayed on a display of the portable communication terminal shown in FIG. 1.

FIG. 10 is a schematic view showing an example of a state where contents of data transferred to the display of the portable communication terminal shown in FIG. 1 is being displayed.

FIG. 11 is a schematic view showing an example of a memory map of a RAM of the portable communication terminal shown in FIG. 3.

FIG. 12 is a schematic view showing an example of a memory map of a RAM of the information terminal shown in FIG. 5.

FIG. 13 is a flowchart showing an example of a data reception processing of the processor of the portable communication terminal shown in FIG. 3.

FIG. 14 is a flowchart showing an example of data transfer management processing of a processor of the information terminal shown in FIG. 5.

FIG. 15 is a sequence chart showing an example of a flow until data is transferred in the data transfer system shown in FIG. 1.

FIG. 16 is a schematic view showing an example of a manner that a data icon is selected in the data transfer system shown in FIG. 1.

FIG. 17 is a schematic view showing an example of a state where additional information is displayed on the display of the portable communication terminal shown in FIG. 1.

### FORMS FOR EMBODYING THE INVENTING

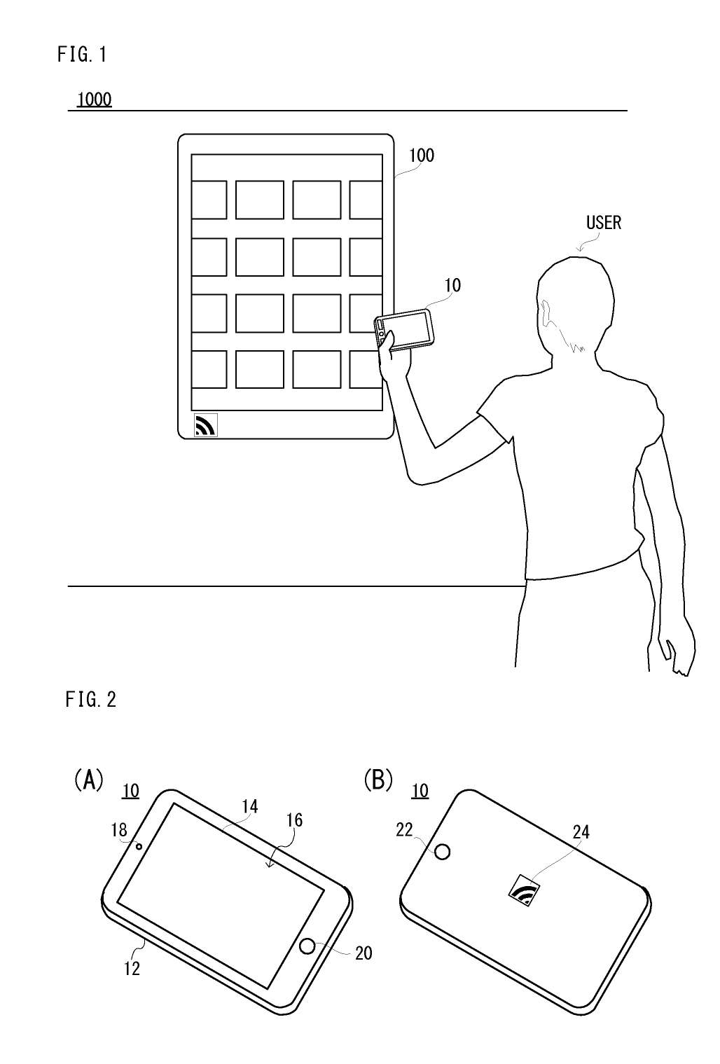

With reference to FIG. 1, a data transfer system 1000 according to an embodiment of the present invention is for distributing a floor guide to a user in a station yard as an example, and includes a portable communication terminal 10 and an information terminal 100. However, it is pointed out in advance that in the present invention, a coupon, etc. other than a floor guide may be distributed, and the system can be installed in a department store, a museum, etc. in addition to the station yard.

The portable communication terminal 10 is a tablet terminal as an example, and is carried by a user. Furthermore, the portable communication terminal 10 displays a floor guide that is received (transferred or acquired) from the information terminal 100. The information terminal 100 is a digital signage as an example, and displays data icons (or thumbnail images) corresponding to data of the floor guide.

For example, a user can make the information terminal 100 data transfer of a necessary floor guide to the portable communication terminal 10 by selecting an arbitrary data icon out of a plurality of data icons (floor guide) currently displayed on the information terminal 100 and performing a reception operation thereof.

Furthermore, the portable communication terminal 10 and the information terminal 100 are connected wirelessly to each other using a short-distance wireless communication of a Wi-Fi system. Therefore, when data transfer is to be performed, data is transferred to the portable communication terminal 10 from the information terminal 100 by the short-distance wireless communication of a Wi-Fi system.

FIG. 2 (A) and FIG. 2(B) are schematic views showing an appearance of the portable communication terminal 10, FIG. 2 (A) shows an appearance of a main surface (front surface) of the portable communication terminal 10, and FIG. 2 (B) shows an appearance of another surface (rear surface) of the portable communication terminal 10.

With referring to FIGS. 2(A) and 2(B), the portable communication terminal 10 includes a longitudinal flat rectangular housing 12. However, it is pointed out in advance that the present invention can be applied to an arbitrary portable communication terminal such as a mobile phone, a PDA, etc.

A display 14 such as a liquid crystal, organic EL, etc. is provided on the main surface (front surface) of the housing 12, which functions as a display module or a second display module. A touch panel 16 is provided on the display 14. Therefore, in the portable communication terminal 10 of this embodiment, the most part of input operations excepting an input by an operation of hardware keys described later is performed through the touch panel 16.

A speaker 18 is housed in the housing 12 at one end of a longitudinal direction on a side of the main surface. A menu key 20 which constitutes an input operation module together with the touch panel 16 is provided on the main surface of the housing.

Furthermore, a lens aperture 22 which communicates with a camera module 44 (see FIG. 2) is provided at one end of the longitudinal direction on a rear surface of the housing 12. Furthermore, an NFC (Near Field Communication) mark 24 is provided at approximately center of the rear surface of the housing 12, which indicates that the rear surface is a surface for performing a short-distance wireless communication (non-contact communication) used with noncontact IC cards such as Felica (registered trademark), etc.

For example, when the menu key 20 is operated, a menu screen is displayed on the display 14. In such a state, by performing a touch operation to a software key, a menu icon, etc. being displayed on the display 14, the user can select a menu and determine such selection.

Furthermore, if a camera function is performed, the camera module 44 is enabled and a preview image (through image) corresponding to a photographic subject is displayed on the display 14. Then, the user can images the photographic subject by turning the rear surface that the lens aperture 22 is provided and performing an imaging operation.

Furthermore, the user can perform a short-distance wireless communication with a further apparatus by holding up another side of the portable communication terminal 10 that the NFC mark 24 is provided over an NFC mark provided on the further apparatus.

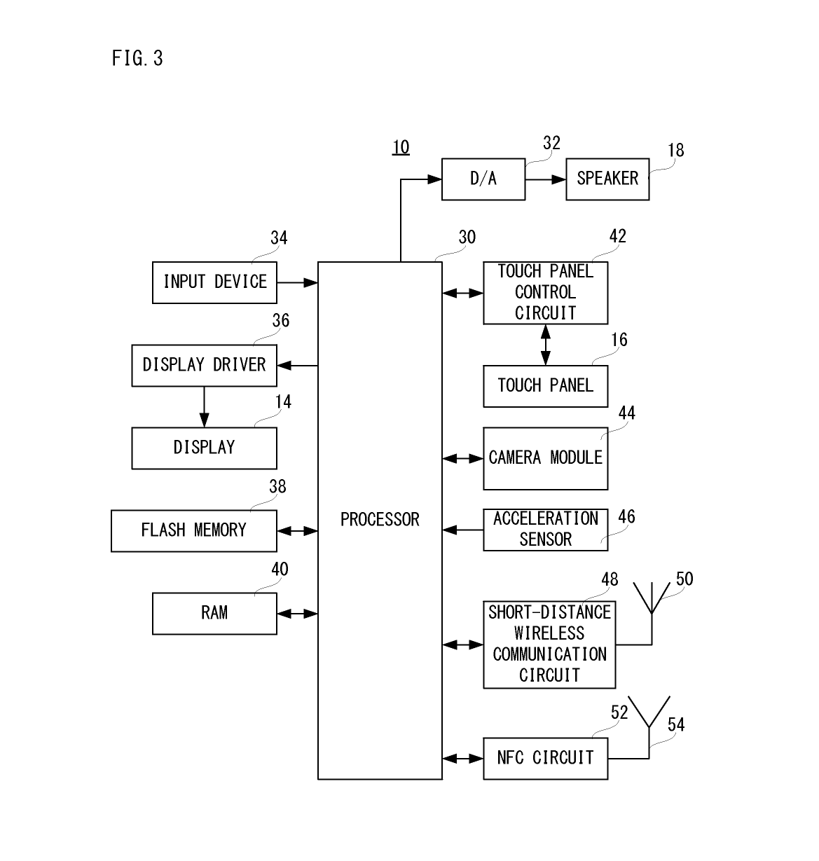

With reference to FIG. 3, the portable communication terminal 10 shown in FIG. 2 includes a processor 30 called a computer or CPU, and so on. The processor 30 is connected with a D/A converter 32, an input device 34, a display driver 36, a flash memory 38, a RAM 40, a touch-panel control circuit 42, the camera module 44, an acceleration sensor 46, a short-distance wireless communication circuit 48, an NFC circuit 52, etc.

The processor 30 is in charge of entire control of the portable communication terminal 10. A whole or a part of a program set in advance in the flash memory 38 is, in use, developed or loaded into the RAM 40, and the processor 30 operates in accordance with the program in the RAM 40. In addition, the RAM 40 is further used as a working area or buffer area for the processor 30.

The input device 34 includes the touch panel 16 and the menu keys 20 both shown in FIG. 2, and constitutes an operation module or an input module. Information (key data) of the hardware key that the user operated is input to the processor 30.

The speaker 18 is connected to the D/A converter 32. The D/A converter 32 converts digital voice data into a voice signal to apply to the speaker 18 via an amplifier. Therefore, a voice of the voice data is output from the speaker 18.

The display driver 36 is connected with the display 14 shown in FIG. 2, and therefore, the display 14 displays a video or image in accordance with video or image data that is output from the processor 30. That is, the display driver 36 controls display by the display 14 connected to the display driver 36 under instructions by the processor 30. Furthermore, the display driver 36 includes a video memory which temporarily stores the video or image data to be displayed. The display 14 is provided with a backlight which includes a light source of an LED, etc., for example, and the display driver 36 controls, according to the instructions from the processor 30, brightness, turning on/off of the backlight.

The touch panel 16 shown in FIG. 2 is connected to the touch panel control circuit 42. The touch panel control circuit 42 applies to the touch panel 16 a necessary voltage or the like, and inputs to the processor 30 a touch start signal indicating a start of a touch to the touch panel 16 by the user, a touch end signal indicating an end of a touch by the user, and coordinate data indicating a touch position that the user touches. Therefore, the processor 30 can determine whether the icon or key being displayed on the display 14 is touched by the user based on the coordinate data.

In the embodiment, the touch panel 16 is of an electrostatic capacitance system that detects a change of an electrostatic capacitance between electrodes, which occurs when an object such as a finger is in close to a surface of the touch panel 16, and it is detected that one or more fingers are brought into contact with the touch panel 16, for example. Furthermore, the touch panel 16 is provided on the display 14. The touch panel control circuit 42 functions as a detection module, and detects a touch operation within a touch-effective range of the touch panel 16, and outputs coordinate data indicative of a position of the touch operation to the processor 30. That is, the user inputs to the portable communication terminal 10 an operating position, an operating direction, etc. by performing a touch, slide or release on the surface of the touch panel 16.

In addition, for a detection system of the touch panel 16, a surface-type electrostatic capacitance system may be adopted, or a resistance film system, an ultrasonic system, an infrared ray system, an electromagnetic induction system, etc. may be adopted. Furthermore, a touch operation is not limited to an operation by a finger, may be performed by a stylus or the like.

The camera module 44 includes a control circuit, a lens, an image sensor, etc. The processor 30 enables the control circuit and the image sensor when an operation for performing a camera function is made. Then, when image data based on a signal that is output from the image sensor is input to the processor 30, a preview image corresponding to the photographic subject is displayed on the display 14.

The acceleration sensor 46 is a 3-axis acceleration sensor of a semiconductor type. The acceleration sensor 46 outputs data of acceleration to the portable communication terminal 10 in three (3) axes (X, Y, Z) to the processor 30. The processor 30 determines a motion of the portable communication terminal 10 by detecting a change of the 3-axis acceleration data. Furthermore, the processor 30 can calculate an inclination angle of the portable communication terminal 10 based on gravitational acceleration that the acceleration sensor 46 detects. Then, the processor 30 may set a displaying direction of the display 14 based on a calculated inclination angle when a posture of the portable communication terminal 10 is changed. Furthermore, the processor 30 can detect direct operation of shaking or moving the portable communication terminal 10 based on the acceleration data that the acceleration sensor 46 outputs.

The short-distance wireless communication circuit 48 is a circuit for performing a short-distance wireless communication in a Wi-Fi system, and connected with a short-distance wireless communication antenna 50. The Wi-Fi (Wireless Fidelity) is a name indicating that an interconnectivity between radio equipment each utilizing a communication standard of IEEE 802, 11 series (IEEE 802, 11a/b/g/n, etc.) are certified by a designated certification agency. That is, the Wi-Fi is one system for a short-distance wireless communication, and the portable communication terminal 10 utilizes the short-distance wireless communication circuit 48 of the Wi-Fi system. Then, in the short-distance wireless communication of the Wi-Fi system, a short-distance wireless communication can be established with an apparatus which functions as an access point. Furthermore, when the portable communication terminal 10 establishes a short-distance wireless communication with the access point, communication establishment information including SSID (Service Set Identifier), a security key, etc. becomes needed.

The NFC circuit 52 is a circuit for performing a proximity wireless communication, and is connected with an NFC antenna 54. The NFC is one system of a short-distance wireless communication that is different from the Wi-Fi, and the NFC may be called a proximity wireless communication or a noncontact communication. Then, in the proximity wireless communication of an NFC system, a wireless communication can be established with an apparatus or a reader/writer having an NFC circuit. In addition, unlike a short-distance wireless communication of a Wi-Fi system, communication establishment information of a proximity wireless communication of the NFC system of this embodiment is unnecessary.

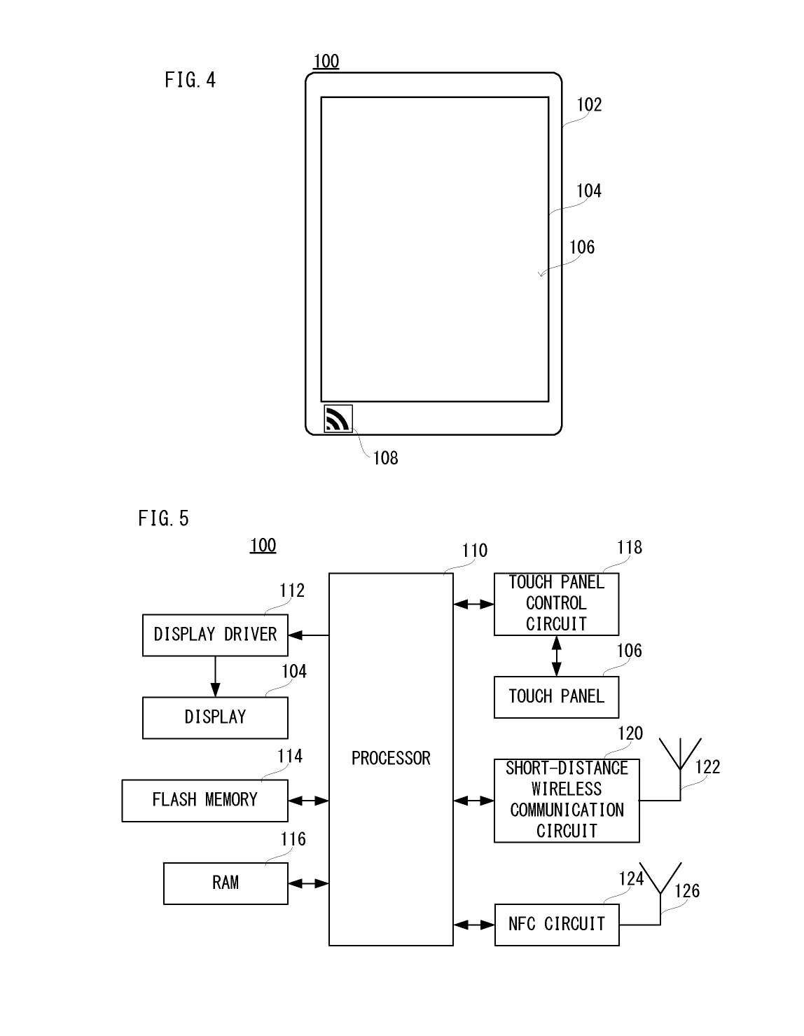

FIG. 4 is a schematic view showing an appearance of the information terminal 100. With referring to FIG. 4, the information terminal 100 includes a longitudinal flat rectangular housing 102 which is larger than those of the portable communication terminal 10. In addition, it is pointed out in advance that this information terminal 100 may be an arbitrary information terminal such as a smartphone, a tablet terminal, a PDA, etc.

A display 104 of a liquid crystal, organic EL or the like is provided on a main surface of the housing 102, which functions a first display module. A touch panel 106 which is a kind of a pointing device is provided on the display 104. Therefore, in the information terminal 100 of this embodiment, an input operation is performed through the touch panel 106.

Furthermore, an NFC mark 108 that is the same as the mark provided on the rear surface of the portable communication terminal 10 is provided in the lower left of the information terminal 100.

By performing an operation to a GUI displayed on the display 104 via the touch panel 106, for example, the user can make a data icon corresponding to desired data (floor guide, etc., for example) to be displayed on the display 104 or can confirm content thereof.

Furthermore, by holding up the rear surface that the NFC mark 24 is provided of the portable communication terminal 10 over the NFC mark 108 of the information terminal 100, the user can establish a proximity wireless communication of an NFC system between the portable communication terminal 10 and the information terminal 100.

In addition, an information terminal of another embodiment may be provided with a speaker which outputs an announcement voice, a microphone for inputting a voice, etc.

With reference to FIG. 5, the information terminal 100 shown in FIG. 4 includes a processor 110 which is called a computer or CPU. A display driver 112, a flash memory 114, a RAM 116, a touch-panel control circuit 118, a short-distance wireless-communication circuit 120, an NFC circuit 124, etc. are connected to the processor 110.

In addition, the short-distance wireless communication circuit 120 and the NFC circuit 124, and the short-distance wireless communication antenna 122 and the NFC antenna 126 that are connected to them are approximately the same as those of the portable communication terminal 10, and therefore, a detailed description thereof is omitted here. However, the short-distance wireless communication circuit 120 of the information terminal 100 operates in an access point mode. The access point mode is a mode that own terminal communicates with a base station, and functions as an access point in a short-distance wireless communication. In a state of operating in the access point mode, it becomes possible for a further terminal to communicate with the base station via the own terminal by a short-distance wireless communication. That is, if operating in the access point mode, the information terminal 100 functions as an access point in a short-distance wireless communication of a Wi-Fi system.

The processor 110 is in charge of entire control of the information terminal 100. The flash memory 114 is stored with a program for operating the information terminal 100, data of a floor guide, etc. A whole or a part of the program set in advance in the flash memory 114 is, in use, developed or loaded into the RAM 116, and the processor 110 operates in accordance with the program in the RAM 116. In addition, the RAM 116 is further used as a working area or buffer area for the processor 110. Furthermore, the flash memory 114 may be called a storing module.

The display 104 shown in FIG. 4 is connected to the display driver 112. The display 104 displays a data icon according to display data that is output from the processor 110. That is, the display driver 112 controls display of the display 104 connected to the display driver 112 under instructions of the processor 110. Furthermore, the display driver 112 includes a video memory which stores display data of the data icon temporarily. The display 104 is provided with a back light of a light source such as an LED, etc., for example.

A touch panel 106 which is provided on the display 104 is connected to the touch panel control circuit 118. The touch panel control circuit 118 applies a necessary voltage, etc. to the touch panel 106. A touch detection system of the touch panel 106 of the information terminal 100 is an electrostatic capacitance system, and the touch panel 106 detects a touch operation that one or more fingers are brought into contact with the touch panel 106. Furthermore, since a sensitivity of the touch panel 106 is set higher, it is possible to detect an operation that a finger, etc. is floated (spaced with a predetermined gap) from the touch panel 106. That is, the user can operate intuitively a GUI that is being displayed on the display 104 without touching the touch panel 106 directly. In addition, in the following description, such an operation is called a floating touch.

The touch panel control circuit 118 inputs to the processor 110 a touch start signal indicating a start of a touch or floating touch to the touch panel 106 by the user, a touch end signal indicating an end of a touch or floating touch by the user, and coordinate data indicating a touch position that the user touches or coordinate data indicating a position that the user performs the floating touch. The processor 110 can determine which data icon is floating-touched by the user based on floating touch coordinate data, for example.

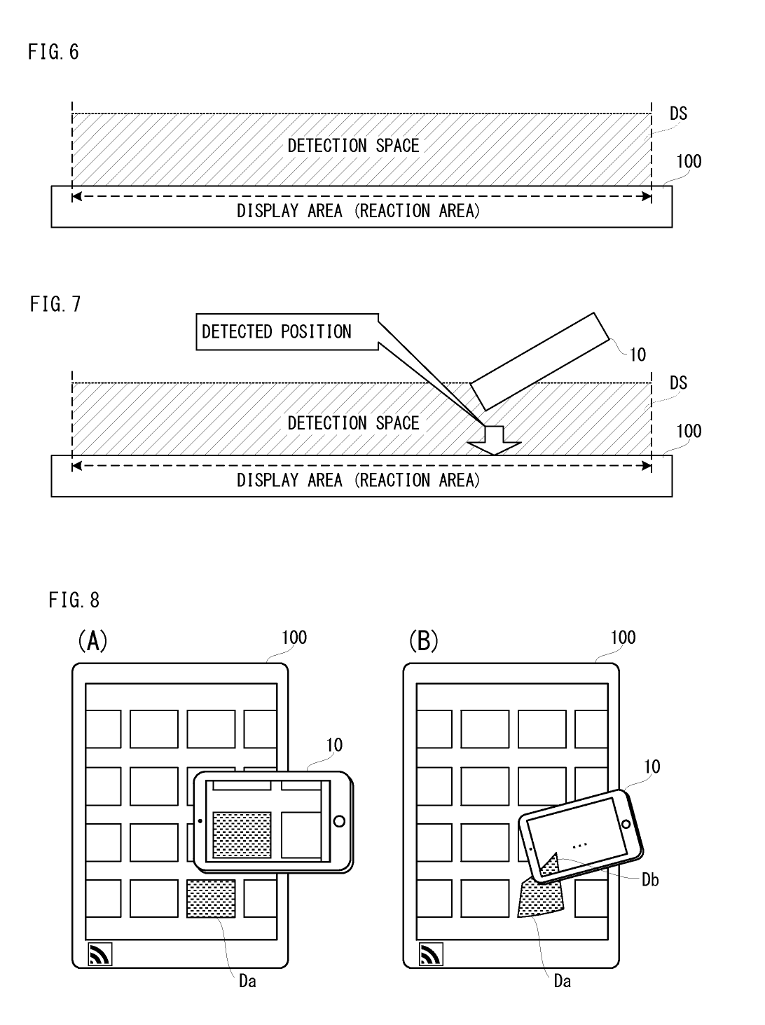

FIG. 6 is a schematic view showing a detection space DS that a floating touch of the touch panel 106 is detected. With reference to FIG. 6, when viewing the information terminal 100 from a side surface, an area of a bottom of the detection space DS corresponds to an area of the display area (reaction area of the touch panel 106) of the display 104. Then, from a surface (surface of the touch panel 106) of the information terminal 100 to a predetermined distance serves as the detection space DS.

With reference to FIG. 7, if the portable communication terminal 10 enters into the detection space DS, such a state is detected as a floating touch by the touch panel 106. Furthermore, a detected position is output to the processor 110 from the touch panel control circuit 118.

Here, in this embodiment, if the data that is to be transferred using the data icon (image) currently displayed on the display 104 of the information terminal 10 is selected and a reception operation is performed, selected data is transferred to the portable communication terminal 10. That is, the user can receive desired data at the portable communication terminal 10. In the following, specific processing will be described.

First, wireless connection of the portable communication terminal 10 and the information terminal 100 will be described. If the user brings the NFC mark 24 (another side of the portable communication terminal 10) close to the NFC mark 108 of the information terminal 100, a proximity wireless communication of an NFC system is performed between the portable communication terminal 10 and the information terminal 100. At this time, the communication establishment information of a Wi-Fi system (SSID and security key) is transmitted from the information terminal 100 to the portable communication terminal 10. In the portable communication terminal 10, receiving the communication establishment information, a short-distance wireless communication of a Wi-Fi system with the information terminal 100 is established based on the information. Furthermore, if a proximity wireless communication is performed, a reception function for receiving data is performed in the portable communication terminal 10.

Next, a selection operation of the data to transfer will be described. If the reception function is performed, the portable communication terminal 10 enables the camera module 44 to display a preview image on the display 14.

With reference to FIG. 8 (A), a plurality of data icons are displayed on the display 104 of the information terminal 100. Furthermore, if the rear side of the portable communication terminal 10 displaying a preview image is turned to the display 104 displaying the data icons, imaged image of the data icons is displayed on the display 14 of the portable communication terminal 10. That is, the user can grasp display of the display 104 of the information terminal 100 interrupted with the portable communication terminal 10 by seeing the image that is imaged by the camera module 44.

With reference to FIG. 8 (B), if the floating touch operation (selection operation) that the user brings the portable communication terminal 10 close to an arbitrary first data icons Da is performed, the information terminal 100 detects a position that the portable communication terminal 10 is approaching. At this time, the information terminal 100 changes the first data icon Da being displayed at a detected position into a state where a part of the first data icon is picked up, i.e., a selected state. That is, it is possible to make the user feel as if the first data icon Da is picked up on the portable communication terminal 10.

Furthermore, the information terminal 100 transmits a second data icon Db relevant to the first data icon Da and meta-information of data corresponding to the first data icon Da to the portable communication terminal 10. Then, the portable communication terminal 10 displays the second data icon Db and the meta-information that are received on the display 14.

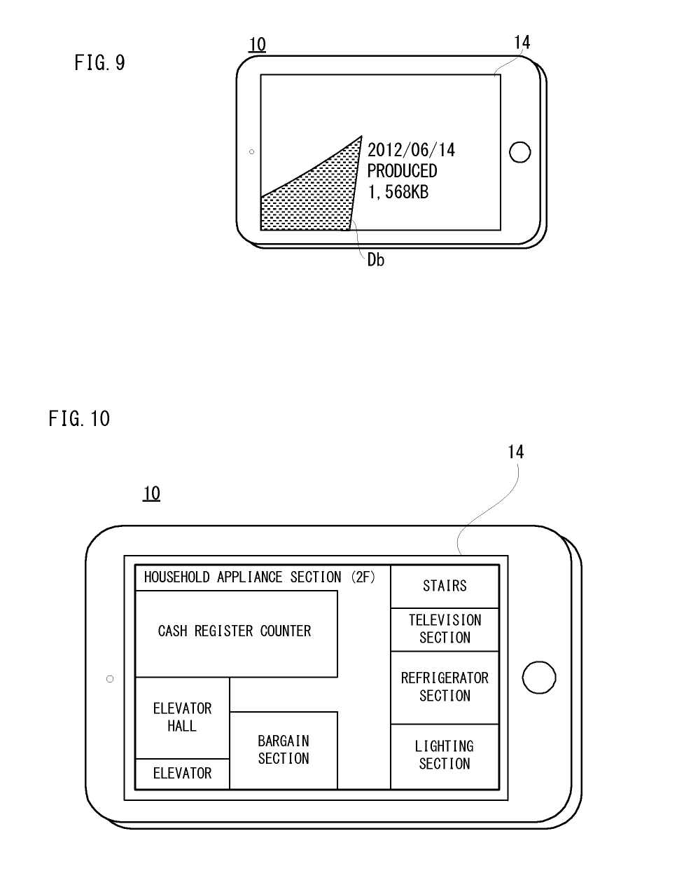

With reference to FIG. 9, the portable communication terminal 10 displays the second data icon Db and the meta-information that are received on the display 14 in place with the preview image. The second data icon Db is represents a part of an upper right portion of the first data icon Da. At this time, if the user looks at the portable communication terminal 10 and the information terminal 100 simultaneously, the user feels as if the first data icon Da being displayed on the display 104 is picked up by the portable communication terminal 10.

Furthermore, the meta-information received simultaneously is displayed at a right side of the second data icon Db. The meta-information includes date (produced on 2012 Jun. 14) that data corresponding to the first data icon Da is produced and a data size (1,568 KB), and these pieces of information are displayed on the display 14. In addition, in another embodiment, meta-information such as an updated date and a producer of the data, etc., may be displayed.

Next, a reception operation of the data to be transferred will be described. If an operation (reception operation) that the portable communication terminal 10 is moved in a manner that the first data icon Da is scooped, for example is performed in a state where the second data icon Db is being displayed on the display 14, the portable communication terminal 10 transmits a transfer request of data corresponding to the first data icon Da to the information terminal 100. Specifically, when an output of the acceleration sensor 46 exceeds a threshold value by a motion such as scoop, the portable communication terminal 10 transmits a transfer request to the information terminal 100.

Thus, the user can make data transfer start by a simple operation of moving the portable communication terminal 10.

With reference to FIG. 10, if the information terminal 100 receives a request for data transfer, data corresponding to first data icon Da is transferred to the portable communication terminal 10. Then, if the data is transferred to the portable communication terminal 10, content of data is displayed on the display 14 while the data is stored.

Thus, in this embodiment, the user can receive arbitrary data only by performing the reception operation while confirming own selection operation.

Especially, the user can receive desired data only by performing operation that a data icon corresponding to the desired data is scooped by the portable communication terminal 10. That is, the user can transfer desired data by an intuitive operation. Furthermore, in this embodiment, since specific data can be transferred by an intuitive operation, erroneous transfer of unnecessary data is suppressed.

Furthermore, the first data icon Da is selected and then, if a floating touch is no longer detected before the reception operation is performed, the second data icon Db displayed on the display 14 of the portable communication terminal 10 is non-displayed, and a preview image becomes to be displayed again. That is, since it is rendered in a state where the first data icon Da is not selected, the display of the second data icon Da is non-displayed. Therefore, even if a user mistakes a selection operation of a data icon, the user can reselect easily.

In addition, in another embodiment, a short-distance wireless communication may be established by an ad-hoc mode in the short-distance wireless communication of a Wi-Fi system. That is, if a short-distance wireless communication is established by the ad-hoc mode, the portable communication terminal 10 and the information terminal 100 directly communicate with each other without an access point of wireless LAN, etc.

Furthermore, in another embodiment, in order to suppress an erroneous operation of the reception operation, a request for data transfer may be transmitted to the information terminal 100 when the receipt operation is performed in a state where the touch panel 16 of the portable communication terminal 10 is being touched. Furthermore, in another embodiment, an operation that the portable communication terminal 10 is shook in right and left and up and down may be rendered as a receipt operation.

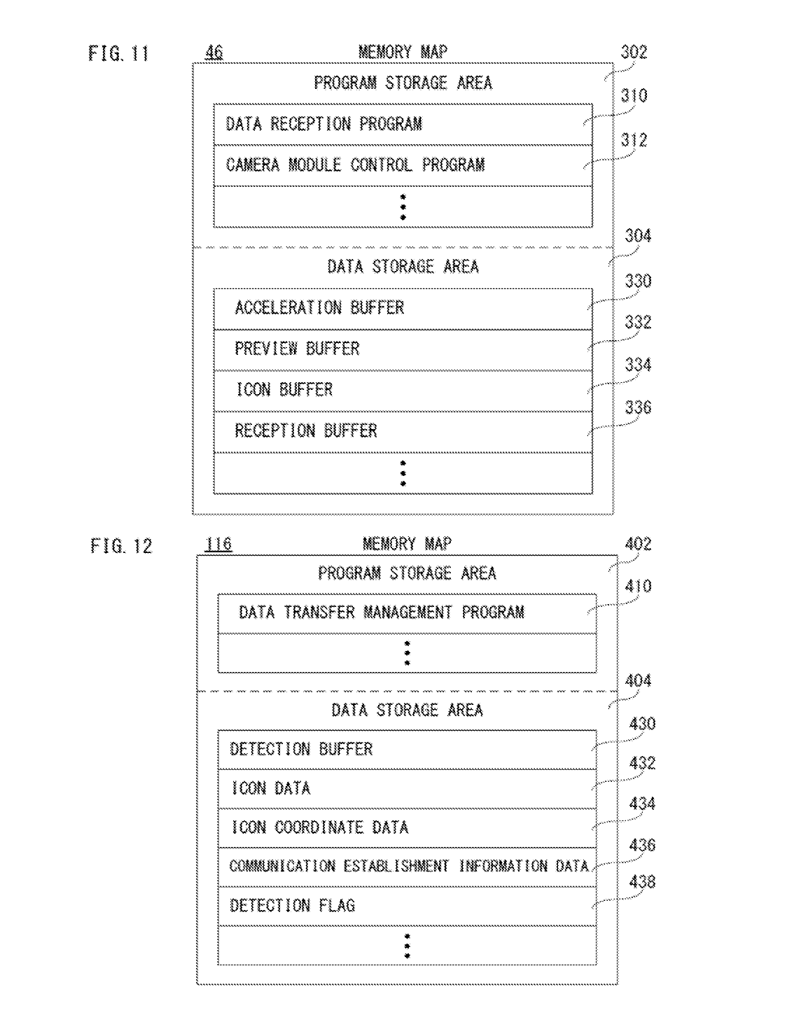

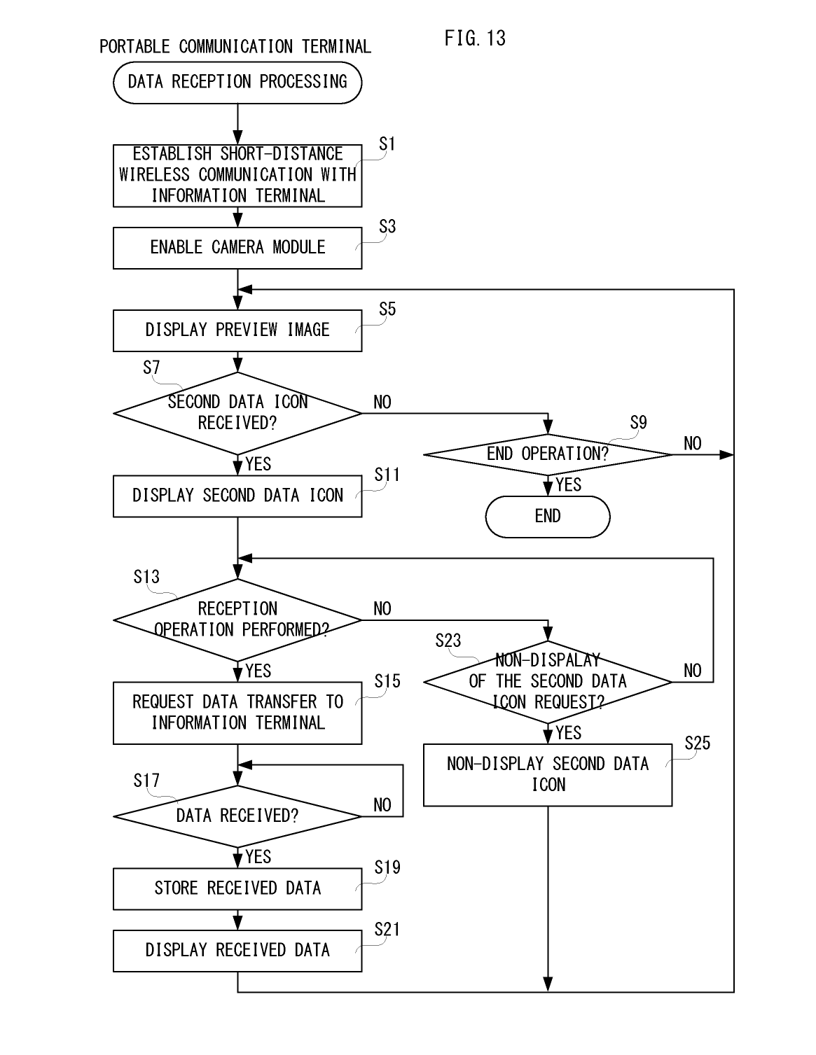

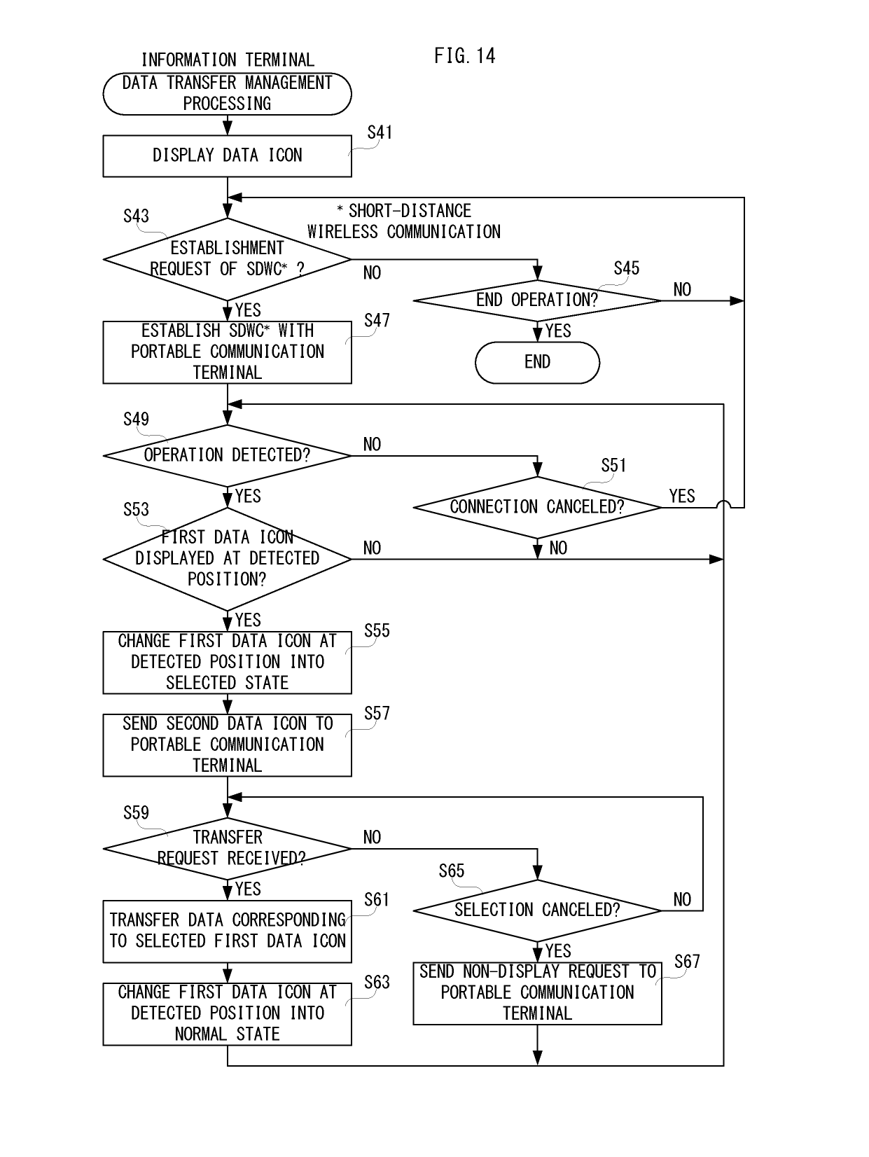

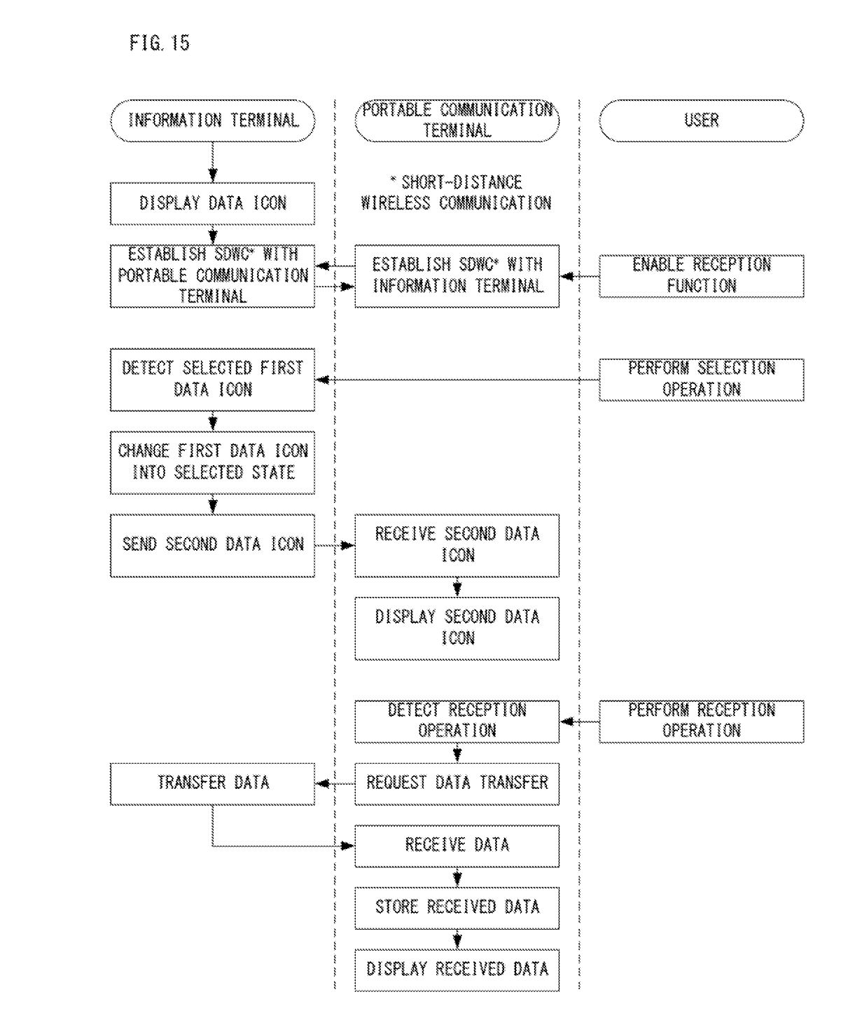

Although the feature of the embodiment is outlined in the above, in the following, a detailed description will be made using memory maps showing in FIG. 11 and FIG. 12, flowcharts shown in FIG. 13 and FIG. 14 and a sequence chart shown in FIG. 15.

With reference to FIG. 11, a program storage area 302 and a data storage area 304 are formed in the RAM 40 of the portable communication terminal 10 shown in FIG. 3. The program storage area 302 is an area for reading and storing (developing) a part or whole of program data that is set in advance in the flash memory 38 (FIG. 2) as described previously.

The program storage area 302 is stored with a data reception program 310 for receiving data transferred from the information terminal 100, a camera module control program 312 for controlling an operation of the camera module 44, etc. In addition, programs for performing a telephone function, etc. are also included in the program storage area 302.

Subsequently, the data storage area 304 of the RAM 40 is provided with an acceleration buffer 330, a preview buffer 332, an icon buffer 334, a reception buffer 336, etc. The acceleration buffer 330 is temporarily stored with acceleration that is output from acceleration sensor 46. The preview buffer 332 is temporarily stored with a preview image based on an image that is output from the camera module 44. A second data icon Db that is transmitted from the information terminal 100 is temporarily stored in the icon buffer 334. The reception buffer 336 is temporarily stored with data that is transferred from the information terminal 100.

The data storage area 304 is stored with image data that is displayed in the standby state, data of character strings, and provided with counters and flags necessary for operation of the portable communication terminal 10.

With reference to FIG. 12, a program storage area 402 and a data storage area 404 are formed in the RAM 116 of the information terminal 100 shown in FIG. 5. As similar to the program storage area 302 of the portable communication terminal 10, the program storage area 402 is an area for reading and storing (developing) a part or whole program data that is set in advance in the flash memory 114 (FIG. 5).

In the program storage area 402, a data transfer management program 410 for transferring data to the portable communication terminal 10, etc. are stored. In addition, a program for displaying a data icon is also included in the program storage area 402.

Subsequently, the data storage area 404 of the RAM 116 is provided with a detection buffer 430, and is stored with icon data 432, icon coordinate data 434 and communication establishment information data 436. Furthermore, a detection flag 438 is also provided in the data storage area 404.

The detection buffer 430 is temporarily stored with data of the touch coordinate and floating touch coordinate that are output from the touch panel control circuit 118.

The icon data 432 is data for displaying a plurality of data icons. The icon coordinate data 434 includes displaying coordinate of the data icon that is being displayed on the display 104. Therefore, if a touch or a floating touch is detected, it is determined whether a touch operation or a floating touch operation is performed to the data icon based on the touch coordinate or the floating touch coordinate currently stored in the detection buffer 430 and the icon coordinate data 434.

The communication establishment information data 436 includes communication establishment information required for performing a short-distance wireless communication of a Wi-Fi system between another terminal (portable communication terminal 10) and the information terminal 100 at a time that the information terminal 100 functions as an access point. Specifically, a character string of the SSID and a security key is included in the communication establishment information data 436 as mentioned above.

The detection flag 438 is a flag for determining whether a touch or a floating touch is performed to the touch panel 106. The detection flag 438 consists of 1-bit register, for example. If the detection flag 438 is turned-on (true), a data value “1” is set into the register. On the other hand, if the detection flag 438 is turned-off (false) a data value “0” is set into the register. In addition, the detection flag 438 is turned on/off based on the signal that the touch panel control circuit 118 outputs.

The data storage area 404 is stored with image data that is displayed in the standby state, data of character strings, and provided with counters and flags necessary for operation of the portable communication terminal 10.

The processor 30 of the portable communication terminal 10 processes a plurality of tasks including data reception processing shown in FIG. 13 in parallel with each other under control of Linux (registered trademark)-base OS such as Android (registered trademark) and REX, or other OSs.

The data reception processing is started, when a proximity wireless communication of an NFC system with the information terminal 100 is established and communication establishment information data is received.

The processor 30 establishes a short-distance wireless communication with the information terminal 100 in a step S1. That is, the processor 30 establishes a short-distance wireless communication with the information terminal 100 based on the SSID and the security key that are included in the communication establishment information data received from the information terminal 100.

Subsequently, the processor 30 enables the camera module 44 in a step S3, and displays a preview image in a step S5. As shown in FIG. 8 (A), for example, a preview image is displayed on the display 14 of the portable communication terminal 10. In addition, the processor 30 performing the processing of the step S5 functions as a preview image display module.

Subsequently, the processor 30 determines in a step S7 whether the second data icon Db is received. That is, it is determined whether the second data icon Db transmitted from the information terminal 100 is received. If “NO” is determined in the step S7, that is, if the second data icon Db is not received, the processor 30 determines in a step S9 whether it is an end operation. For example, it is determined whether the menu key 20 is operated. If “YES” is determined in the step S9, that is, if the end operation is performed, the processor 30 cancels the communication with the information terminal 100, and terminates the data reception processing. On the other hand, if “NO” is determined in the step S9, that is, if the end operation is not performed, the processor 30 returns to the step S5.

Furthermore, if “YES” is determined in the step S7, that is, if the second data icon Db is received, the processor 30 displays the second data icon Db in a step S11. As shown in FIG. 9, for example, the second data icon Db is displayed on the display 14. In addition, the processor 30 performing the processing of the step S11 functions as a display processing module.

Subsequently, the processor 30 determines in a step S13 whether a reception operation is performed. For example, it is determined whether the portable communication terminal 10 is moved so as to scoop the data icon, and the acceleration currently stored in the acceleration buffer 330 exceeds a threshold value. If “YES” is determined in the step S13, that is, if the reception operation is performed, the processor 30 requests transfer of data from the information terminal 100 in a step S15. That is, the processor 30 transmits a transfer request of data corresponding to the first data icon Da to the information terminal 100. In addition, the processor 30 performing the processing of the step S15 functions as a causing module.

Subsequently, the processor 30 determines in a step S17 whether the data is received. That is, it is determined whether the data that the information terminal 100 transmits in response to the transfer request is received. If “NO” is determined in the step S17, that is, if the data is not received from the information terminal 100, the processor 30 repeats the step S17.

Furthermore, if “YES” is determined in the step S17, that is, if the data is received from the information terminal 100, the processor 30 stores received data in a step S19. The received data is stored in the flash memory 38 after stored once in the reception buffer 336, for example. In addition, the processor 30 performing the processing of the step S19 functions as a storing module.

Subsequently, the processor 30 displays the received data in a step S21. The received data is displayed on the display 14 as shown in FIG. 10, for example. Then, after the processing of the step S21 is completed, the processor 30 returns to the step S5.

Furthermore, if “NO” is determined in the step S13, that is, if the reception operation is not performed, the processor 30 determines in a step S23 whether non-display of the second data icon Db is requested. If the user separates the portable communication terminal 10 from the first data icon Da, for example, since it becomes in a state where the first data icon Da is not selected, the information terminal 100 requests to the portable communication terminal 10 to non-display the display of the second data icon Db. Then, in a step S23, it is determined whether a non-display request that is thus transmitted is received.

If “NO” is determined in the step S23, that is, if there is no non-display request, the processor 30 returns to the step S13. On the other hand, if “YES” is determined in the step S23, that is, if a non-display request is received, the processor 30 non-displays the display of the second data icon Db in a step S25. As shown in FIG. 9, for example, when the second data icon Db is displayed, the second data icon Db is non-displayed. Then, after the processing of the step S25 is completed, the processor 30 returns to the step S5. In addition, the processor 30 performing the processing of the step S25 functions as a non-display module.

The processor 110 of the information terminal 100 processes a plurality of tasks including data transfer management processing shown in FIG. 14 in parallel with each other under control of Linux (registered trademark)-base OS such as Android (registered trademark) and REX, or other OSs.

The data transfer management processing is started if the power supply of the information terminal 100 is turned on. The processor 110 displays data icons in a step S41. As shown in FIG. 8 (A), etc., for example, a plurality of data icons are displayed on the display 104.

Subsequently, the processor 110 determines in a step S43 whether there is a request for establishing a short-distance wireless communication. That is, the NFC mark 24 of the portable communication terminal 10 is held up over the NFC mark 108 of the information terminal 100, and it is determined whether a proximity wireless communication of an NFC system is established. If “NO” is determined in the step S43, that is, if there is no request for establishing a short-distance wireless communication, the processor 110 determines in a step S45 whether an end operation is performed. For example, it is determined whether an end operation turning off the power supply of the information terminal 100 is performed. If “YES” is determined in the step S45, that is, if the end operation is performed, the processor 110 terminates the data transfer management processing. On the other hand, if “NO” is determined in the step S45, that is, if the end operation is not performed, the processor 110 returns to the step S43.

If “YES” is determined in the step S43, that is, if there is a request for establishing a short-distance wireless communication, the processor 110 establishes a short-distance wireless communication with the portable communication terminal 10 in a step S47. First, the processor 110 transmits the communication establishment information data 436 to the portable communication terminal 10. Then, if a request for establishing a short-distance wireless communication is sent from the portable communication terminal 10, based on the sent communication establishment information, a short-distance wireless communication with the portable communication terminal 10 is established.

Subsequently, the processor 110 determines in a step S49 whether an operation is detected. For example, it is determined whether a floating touch operation is performed by means of the portable communication terminal 10, etc. Specifically, the processor 110 determines whether the detection flag 438 is turned on. If “NO” is determined in the step S49, the processor 110 determine in a step S51 whether connection is canceled. For example, the processor 110 determines whether the reception function is ended at the portable communication terminal 10 and thus the connection of the short-distance wireless communication is canceled. If “YES” is determined in the step S51, that is, if the connection is canceled, the processor 110 returns to the step S43. On the other hand, if “NO” is determined in the step S51, that is, if the short-distance wireless communication is not canceled, the processor 110 returns to the step S49.

If “YES” is determined in the step S49, that is, if the floating touch operation is detected, for example, the processor 110 determines in a step S53 whether the first data icon Da is displayed at a detected position. That is, it is determined whether a selection operation is performed to the first data icon Da. Specifically, the processor 110 determines whether a current floating touch position being stored in the detection buffer 430 is included in the display coordinate of the data icon included the icon coordinate data 434. If “NO” is determined in the step S53, that is, if the first data icon Da is not selected, the processor 110 returns to the step S49.

If “YES” is determined in the step S53, that is, if the first data icon Da is selected as shown in FIG. 8 (B), for example, the processor 110 changes the first data icon Da at the detected position into a selected state in a step S55. That is, the first data icon Da shown in FIG. 8 (A) is changed into a state of the first data icon Db shown in FIG. 8 (B). Subsequently, the processor 110 transmits the second data icon Db to the portable communication terminal 10 in a step S57. The second data icon Db shown in FIG. 8 (B) and the meta-information of the data corresponding to the first data icon Da are transmitted to the portable communication terminal 10. In addition, the processor 110 performing the processing of the step S57 functions as a transmitting module.

Subsequently, the processor 110 determines in a step S59 whether a transfer request is received. It is determined whether a transfer request of the data is transmitted from the portable communication terminal 10 by performing by the user a reception operation, for example. If “YES” is determined in the step S59, that is, if a transfer request is received from the portable communication terminal 10, the processor 110 transfers in a step S61 the data corresponding to the selected first data icon Da. As shown in FIG. 8 (B), for example, the data corresponding to the first data icon Da is transferred to the portable communication terminal 10. In addition, the processor 110 performing the processing of the step S61 functions as a transfer module.

Subsequently, the processor 110 changes the first data icon Da of the detected position into a normal state in a step S63. For example, the first data icon Da of the selective state shown in FIG. 8 (B) returns to the state of the first data icon Da shown in FIG. 8 (A). Then, if the processing of the step S63 is completed, the processor 110 returns to the step S49.

Furthermore, if “NO” at the step S59, that is, if a transfer request is not received from the portable communication terminal 10, the processor 110 determines in a step S65 whether the selection is canceled. For example, the processor 110 determines in the step S65 whether the portable communication terminal 10 is separated from the touch panel 106 and thus a floating touch is no longer detected. If “NO” is determined in the step S65, that is, if the current selection is maintained, the processor 110 returns to the step S59. On the other hand, if “YES” is determined in the step S65, that is, if another data icon is selected or a touch operation or floating touch operation is no longer detected, the processor 110 transmits a non-display request to the portable communication terminal 10 in a step S67. That is, the portable communication terminal 10 is requested to non-display the display of the second data icon Da. Then, if the processing of the step S67 is completed, the processor 110 returns to the step S49. In addition, it is determined “YES” in the step S65 when another data icon is selected than the data icon that is currently selected because the floating touch position of the portable communication terminal 10 changes.

FIG. 15 is a sequence chart indicating a flow until data is transferred in the data transfer system 1000. With reference to FIG. 15, in the sequence chart, the information terminal 100, the portable communication terminal 10 and the user operations are included.

First, if the power supply of the information terminal 100 is turned on, data icons are displayed on the display 104. At this time, if the user holds up the NFC mark 24 of the portable communication terminal 10 over the NFC mark 108 of the information terminal 100 to perform reception function, a short-distance wireless communications between the portable communication terminal 10 and the information terminal 100 is established.

Next, if the user performs a selection operation to the first data icon Da, the information terminal 100 detects the first data icon Da being selected. Furthermore, the information terminal 100 changes the display of the selected first data icon Da into a selected state, and transmits a second data icon Db relevant to the selected first data icon Da to the portable communication terminal 10. The portable communication terminal 10 displays the second data icon Db on the display 14 if receiving the same.

Next, if the user performs a reception operation, the portable communication terminal 10 detects that operation. Furthermore, according to the reception operation, the portable communication terminal 10 requests transfer of data corresponding to the first data icon Da to the information terminal 100. The information terminal 100 transfers the data corresponding to the first data icon Da to the portable communication terminal 10 in response to the data transfer request. If transferred data is received, the portable communication terminal 10 stores the data into the flash memory 38, and displays the content of the data on the display 14.

Thus, the user using the data transfer system 1000 can transfer required data to the portable communication terminal 10 from the information terminal 100 through an intuitive operation.

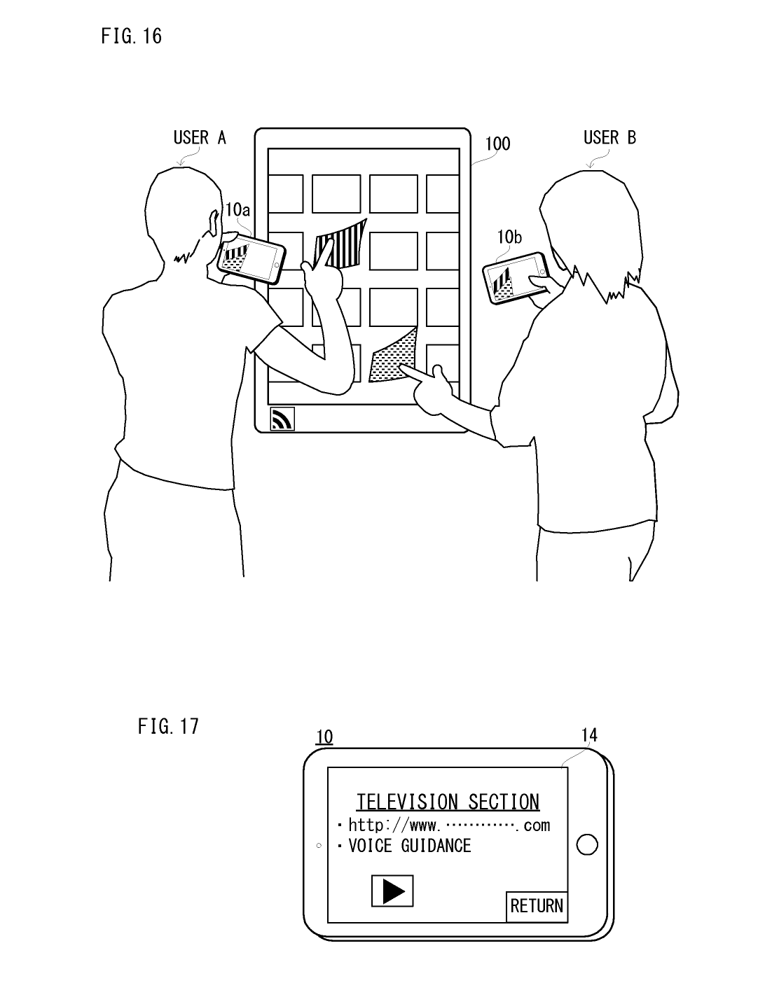

Furthermore, in the data transfer system 1000, data transfer may be performed from the information terminal 100 to a plurality of portable communication terminals 10. With reference to FIG. 16, for example, if a user B makes a portable communication terminal 10b perform a data reception function after a user A makes a portable communication terminal 10a perform the data reception function, the information terminal 100 establishes a short-distance wireless communication with each of the portable communication terminal 10a and the portable communication terminal 10b. If a different first data icon Da is selected by the user A and the user B in this state, the same second data icon Db is displayed on each of two portable communication terminals 10a and 10b. Then, if the user A and the user B perform a reception operation on the portable communication terminals 10a and 10b, respectively, the same data is transferred to the two portable communication terminals 10a and 10b. In addition, in another embodiment, when one user performs the reception operation, data may be transferred to the two portable communication terminals 10a and 10b.

Furthermore, as shown in FIG. 16, a selection operation of the first data icon Da may be performed by a hand (finger), etc. of the user instead of the portable communication terminal 10.

In addition, when data (data that a copy is inhibited by a copyright, for example, etc.) that cannot be transferred out of the data icons currently displayed on the information terminal 100 is selected, a character string indicating that it is impossible to transfer data together with the second data icon Db may be displayed on the display 14 of the portable communication terminal 10.

Furthermore, as for a short-distance wireless communication, a Bluetooth (registered trademark) system may be adopted in another embodiment.

Furthermore, instead of the acceleration sensor 46, a direct operation of shaking or moving the portable communication terminal 10 by a gyro sensor, etc. may be detected.

Furthermore, an operation that is performed on the surface of the display 104 of the information terminal 100 may be detected by a pointing device using not the electric capacity-type touch panel 106 but an infrared sensor, an ultrasonic sensor, a laser sensor, etc.

Furthermore, data possible to be transferred is document data, music data, image data, video data, etc., for example. Furthermore, in a case of the image data or the video data, instead of a data icon, a thumbnail image may be displayed on the display 104.

Furthermore, the user may set arbitrarily whether a preview image is to be displayed when the data receipt function is performed.

Furthermore, in another embodiment, additional information such as a Web site address, etc. may be applied to the floor guide shown in FIG. 10 as store information. In this case, a hyperlink is set such that a function (Web site browsing, for example) based on those information can be performed, and it is displayed on the display 14 that the hyperlink is set. Furthermore, sound information may be included as the additional information of the data acquired from the information terminal 100. When sound information is included, it is set such that the sound information may be reproduced based on a user's operation. However, even if there is no user's operation, after the portable communication terminal 10 acquires data, the sound information may be reproduced automatically.

An example of the above-mentioned manner is shown in FIG. 17. FIG. 17 is an example of a screen that is displayed on the display 14 after the user selects a television section in the display of the portable communication terminal 10 shown in FIG. 10. In the screen of FIG. 17, a telephone number, a Web site address and sound information are set as additional information, and if each item is selected, browser starting or reproduction of the sound information is performed as a function corresponding to each of additional information. Therefore, in such a further embodiment, the user can acquire more information from the information terminal 100. Furthermore, a telephone number may be included in the additional information in the further embodiment. Then, when the portable communication terminal 10 has a telephone function, a telephone calling may be performed based on the telephone number of the additional information.

The programs used in the embodiments may be stored in an HDD of the server for data distribution, and distributed to the portable communication terminal 10 via the network. The plurality of programs may be stored in a storage medium such as an optical disk of CD, DVD, BD (Blu-ray Disc) or the like, a USB memory, a memory card, etc. and then, such the storage medium may be sold or distributed. In a case where the programs downloaded via the above-described server or storage medium are installed to a portable terminal having the structure equal to the structure of the embodiments, it is possible to obtain advantages equal to the advantages according to the embodiments.

The specific numerical values mentioned in this specification are only examples, and changeable appropriately in accordance with the change of product specifications.

It should be noted that reference numerals inside the parentheses and the supplements show one example of a corresponding relationship with the embodiments described above for easy understanding of the present invention, and do not limit the present invention.

An embodiment is a portable communication terminal capable of performing a short-distance wireless communication with an information terminal that displays a first image corresponding to stored data, comprising: a display module; an operation module; a display processing module that displays a second image relevant to the first image that is transmitted from the information terminal; a causing module that causes the information terminal to perform transfer of data corresponding to the first image when a reception operation is performed to the operation module during display of the second image; and a storing module that stores transferred data.

In the embodiment, the portable communication terminal (10: a reference numeral exemplifying a module corresponding in the embodiment, and so forth) is able to establish a short-distance wireless communication with the information terminal. This information terminal is installed in a station yard, etc., for example. The display module (14) displays the first image (data icon Da) corresponding to the data that is stored in the information terminal, for example. The operation module (46) receives a direct operation of shaking or moving the portable communication terminal. If the user selects the first image, for example, the information terminal transmits the second image relevant to the first image to the portable communication terminal. The display processing module (30, S11) displays the second image that is received on the display module. The causing module (30, S15) causes the information terminal to transfer the data corresponding to the first image when the user performs a reception operation to the portable communication terminal, for example. The information terminal transfers the data corresponding to the first image to the portable communication terminal in response to a request. When the data that is thus transferred is received, the storing module (30, S19) stores the data.

According to the embodiment, the user can receive arbitrary data only by performing a reception operation while confirming a selection operation by himself/herself.

Another embodiment further comprises a non-display module that non-displays the display of the second image when a non-display of the second image is requested.

In this embodiment, if the selection to the first image is canceled or a further first image is selected, for example, the information terminal transmits a non-display request of the second image to the portable communication terminal. The non-display module (30, S25) non-displays the display of the second image when the non-display request thus transmitted is received.

According to this embodiment, even if the user mistakes a selection operation of an image, the user re-select easily.

A further embodiment further comprises a camera module and a preview image display module that displays a preview image based on an image that the camera module outputs when a short-distance wireless communication with the information terminal is established.

In the further embodiment, the camera module (44) images a photographic subject through a lens aperture provided on a surface (rear surface) opposite to a surface (main surface) that the display module is provided, for example, and outputs an imaged image. A preview image display module (30, S5) displays a preview image based on the image that the camera module outputs if a short-distance wireless communication with an information terminal is established. That is, the display of the information terminal interrupted with the portable communication terminal is displayed on the display module of the portable communication terminal.

According to the further embodiment, the user can grasp the display of the information terminal interrupted with the portable communication terminal by seeing the image that is imaged by the camera module.

In a still further embodiment, the operation module includes an acceleration sensor, and the causing module causes the information terminal to transfer the data corresponding to the first image when acceleration that the acceleration sensor outputs becomes equal to or more than a threshold value.

In the still further embodiment, the acceleration sensor (46) outputs the acceleration when the portable communication terminal is moved, for example. Then, the causing module requests the transfer of the data corresponding to the first image if the reception operation is performed to the portable communication terminal and the acceleration that the acceleration sensor outputs becomes equal to or more than the threshold value.

According to the still further embodiment, the user can make data transfer start by a simple operation of moving the portable communication terminal.

In a yet further embodiment, the first image and the second image include one of a thumbnail and an icon.

The other embodiment is a data receiving method in a portable communication terminal (10) that can performs a short-distance wireless communication with an information terminal (100) that displays a first image corresponding to stored data, and has a display module (14) and an operation module (46), a processor of the portable communication terminal executing steps of: a display processing step (S11) that displays a second image relevant to the first image that is transmitted from the information terminal; a causing step (S15) that causes the information terminal to perform transfer of data corresponding to the first image when a reception operation is performed to the operation module during display of the second image; and a storing step (S19) that stores transferred data.

According also to the other embodiment, the user can receive arbitrary data only by performing a reception operation while confirming a selection operation by himself/herself.

Although the present invention has been described and illustrated in detail, it is clearly understood that the same is by way of illustration and example only and is not to be taken by way of limitation, the spirit and scope of the present invention being limited only by the terms of the appended claim.

### DESCRIPTION OF NUMERALS

10 - - - portable communication terminal
14 - - - display
16 - - - touch panel
22 - - - lens aperture
24 - - - NFC mark
30 - - - processor
34 - - - input device
38 - - - flash memory
40 - - - RAM
42 - - - touch panel control circuit
44 - - - camera module
46 - - - acceleration sensor
48 - - - short-distance wireless communication circuit
50 - - - short-distance wireless communication antenna
52 - - - NFC circuit
54 - - - NFC antenna
100 - - - information terminal
104 - - - display
106 - - - touch panel
108 - - - NFC mark
110 - - - processor
114 - - - flash memory
116 - - - RAM
118 - - - touch pane control circuit
120 - - - short-distance wireless communication circuit
122 - - - short-distance wireless communication antenna
124 - - - NFC circuit
126 - - - NFC antenna
1000 - - - data transfer system

1. A portable communication terminal capable of performing a short-distance wireless communication with an information terminal that displays a first image corresponding to stored data, comprising:
a display module;
an operation module;
a display processing module operable to display a second image relevant to the first image that is transmitted from the information terminal;
a causing module operable to cause the information terminal to perform transfer of data corresponding to the first image when a reception operation is performed to the operation module during display of the second image; and
a storing module operable to store transferred data.

2. The portable communication terminal according to claim 1, further comprising a non-display module operable to non-display the display of the second image when a non-display of the second image is requested.

3. The portable communication terminal according to claim 1, further comprising a camera module and a preview image display module operable to display a preview image based on an image that the camera module outputs when a short-distance wireless communication with the information terminal is established.

4. The portable communication terminal according to claim 1, wherein the operation module includes an acceleration sensor, and the causing module causes the information terminal to transfer the data corresponding to the first image when acceleration that the acceleration sensor outputs becomes equal to or more than a threshold value.

5. The portable communication terminal according to claim 1, wherein the first image and the second image include one of a thumbnail and an icon.

6. A data receiving method in a portable communication terminal that can performs a short-distance wireless communication with an information terminal that displays a first image corresponding to stored data, and has a display module and an operation module, a processor of the portable communication terminal executing steps of:
a display processing step operable to display a second image relevant to the first image that is transmitted from the information terminal;
a causing step operable to cause the information terminal to perform transfer of data corresponding to the first image when a reception operation is performed to the operation module during display of the second image; and
a storing step operable to store transferred data.
